(19) United States
(12) Patent Application Publication
(10) Pub. No.: US 2008/0014297 A1
(43) Pub. Date: Jan. 17, 2008

(54) System for supplying molding compounds

(75) Inventors: Yun-Lung Chang, Kaohsiung (TW); Yu-Chang Tsai, Kaohsiung (TW); Ming-Wei Sun, Kaohsiung (TW)

Correspondence Address: BIRCH STEWART KOLASCH & BIRCH, PO BOX 747, FALLS CHURCH, VA, 22040-0747, US

(73) Assignee: Advanced Semiconductor Engineering, Inc.

(21) Appl. No.: 11/645,696

(22) Filed: Dec. 27, 2006

(30) Foreign Application Priority Data
Jun. 13, 2006 (TW) 95121064

(51) Int. Cl. B29C 71/00

(52) U.S. Cl. 425/449

(57) ABSTRACT

A system for supplying molding compounds comprising: a barrel, having a plurality of storage holes for storing a plurality of molding compounds; a first push rod below the barrel pushing the plurality of molding compounds within the storage holes; a holder above the barrel holding the molding compounds pushed by the first push rod; a carrier having a plurality of placing holes for the holder putting the plurality of molding compounds, wherein the holder moves to a predetermined position after putting the molding compounds; and a second push rod below the predetermined position pushing the molding compounds located in the placing holes, and then the holder holding the molding compounds and transporting to a mold.

### FIELD OF THE INVENTION

The present invention relates to a system for supplying molding compounds, more particularly to that a system is capable of switching a barrel.

### BACKGROUND OF THE INVENTION

Referring to the FIG. 1, which illustrates a system supplying molding compounds of a prior art. The system 100 has a storage barrel 102 for molding compounds, an oscillating plate 106, a carrier 108, a push rod 110, a holder 112, and a mold 114. The storage barrel 102 stores a plurality of molding compounds 104. The oscillating plate 106 is placed upon the storage barrel 102 and connects the opening 1022 of the storage barrel 102, then the molding compounds 104 is moved to the oscillating plate 106 by air suction or air-blow. Inside the oscillating plate 106 is a helix track 1062, which spirals upward from a bottom of the oscillating plate 106. A bottom end 104 of the helix track 1062 is near the opening 1022 of the storage barrel 102, and a top of the helix track 1062 is near the carrier 108. The molding compounds 104 are delivered upward along the helix track 1062 by oscillating.

The carrier 108 has a plurality of placing holes 1082 and is placed right beside an outlet of the helix track 1062 to carry the molding compounds 104 out from the helix track 1062. When the molding compounds 104 are placed into all the placing holes 1082, the carrier 108 is turned 90 degrees to adjust the direction of the placing holes 1082 and moves to an upper side of the push rod 110. The push rod 110 urges the molding compounds 104 out from the carrier 108. And then the holder 112 holds the released molding compounds 104 and transports them to a mold 114.

However, the system for supplying molding compounds 100 in prior arts has the oscillating plate 106 likely causing powder very easily. Therefore to clean and maintain the helix track 1062 is inconvenient, and it likely causes machinery breakdown. After the storage barrel molding compounds 102 and the oscillating plate 106 finish supplying the first kind of the molding compounds 104, it comes the second kind of the molding compounds 104, it would result in the problem of the mixing different kinds of molding compounds.

### SUMMARY OF THE INVENTION

The primary objective of the present invention is to provide a system for supplying molding compounds. Firstly, a plurality of molding compounds are arranged into a special barrel, and the molding compounds in the same barrel have the same specification and composition. By means of a push rod, the molding compounds are pushed out from the barrel so as to prevent the problem in prior arts, since there is not an oscillating plate

In accordance with the present invention, which provides the system for supplying molding compounds comprising: a barrel, having a plurality of storage holes for storing a plurality of molding compounds; a first push rod below the barrel for pushing the plurality of molding compounds within the storage holes; a holder above the barrel for holding the molding compounds pushed by the first push rod; a carrier having a plurality of placing holes for the holder putting the plurality of molding compounds, wherein the holder moves to a predetermined position after putting the molding compounds; and a second push rod below the predetermined position for pushing the molding compounds located in the placing holes, and then the holder holding the molding compounds and transporting to a mold.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a schematic view of a system for supplying molding compounds of a prior art;

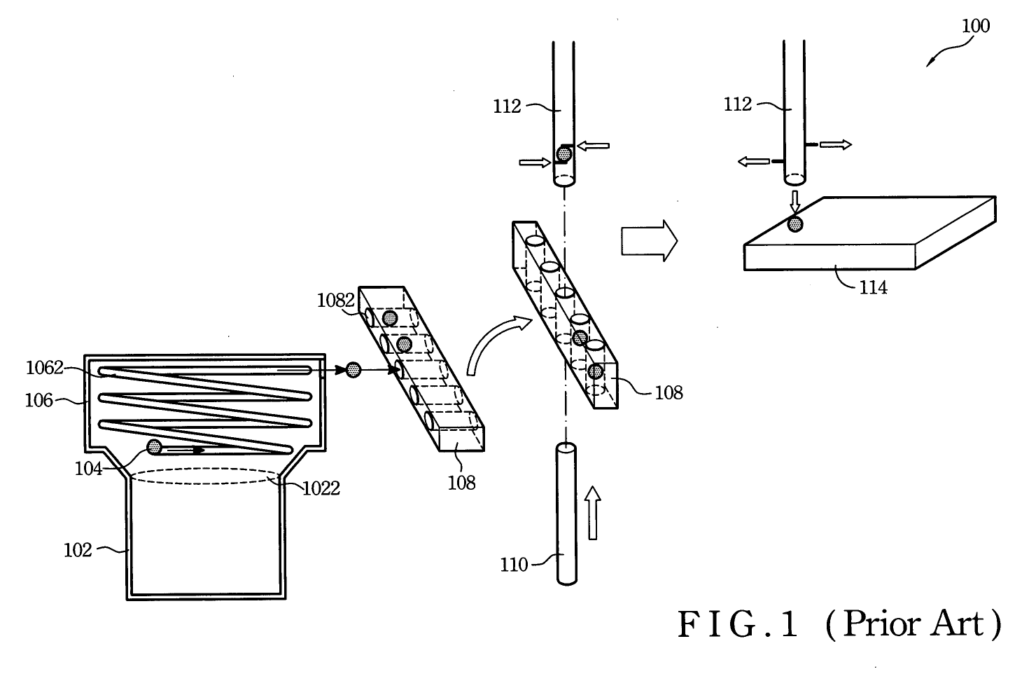

FIG. 2 is a schematic view of a system for supplying molding compounds of the present invention; and

FIG. 3 is a schematic lateral view of a machine for arranging molding compounds of the present invention.

### DETAILED DESCRIPTIONS OF THE PREFERRED EMBODIMENT

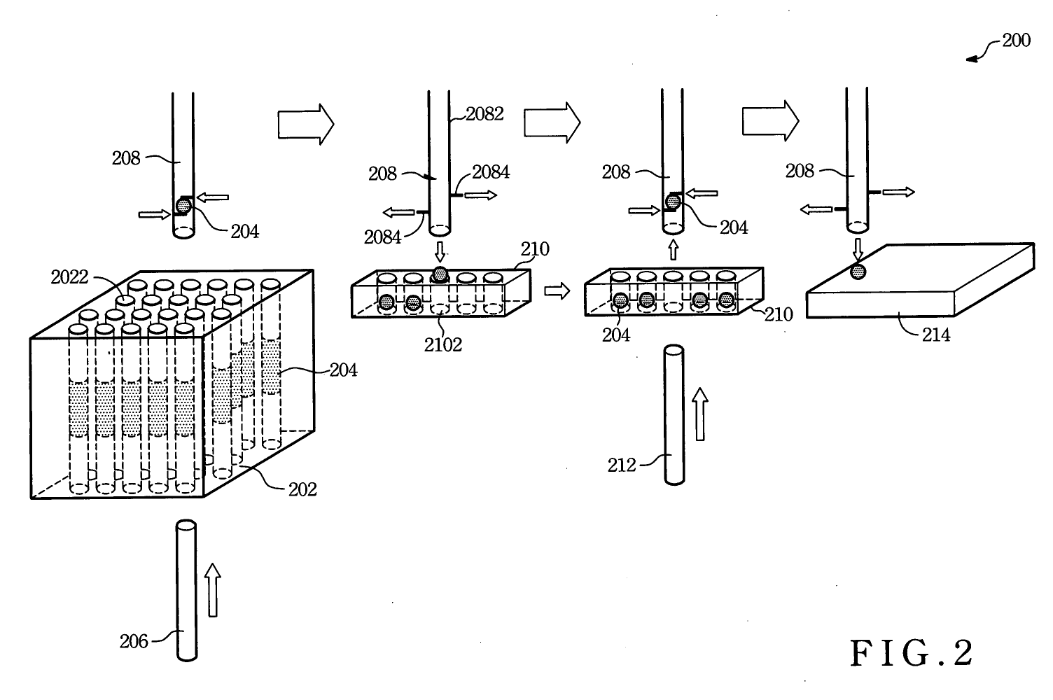

Please refer to FIG. 2, which is a schematic view of a system for supplying molding compounds. The system 200 has a barrel 202, a first push rod 206, a holder 208, a carrier 210, and a second push rod 212. The barrel 202 has a plurality of storage holes 2022 for storing a plurality of molding compounds 204; a first push rod 206 below the barrel 202 pushes the plurality of molding compounds 204 within the storage holes 2022; a holder 208 above the barrel 202 holds the molding compounds 204 pushed by the first push rod 206; a carrier 210 has a plurality of placing holes 2102 for the holder 208 putting the plurality of molding compounds 204, wherein the holder 208 moves to a predetermined position after putting the molding compounds 204; and a second push rod 212 below the predetermined position pushes the molding compounds 204 located in the placing holes 2102, and then the holder 208 holds the molding compounds and transports them to a mold 214.

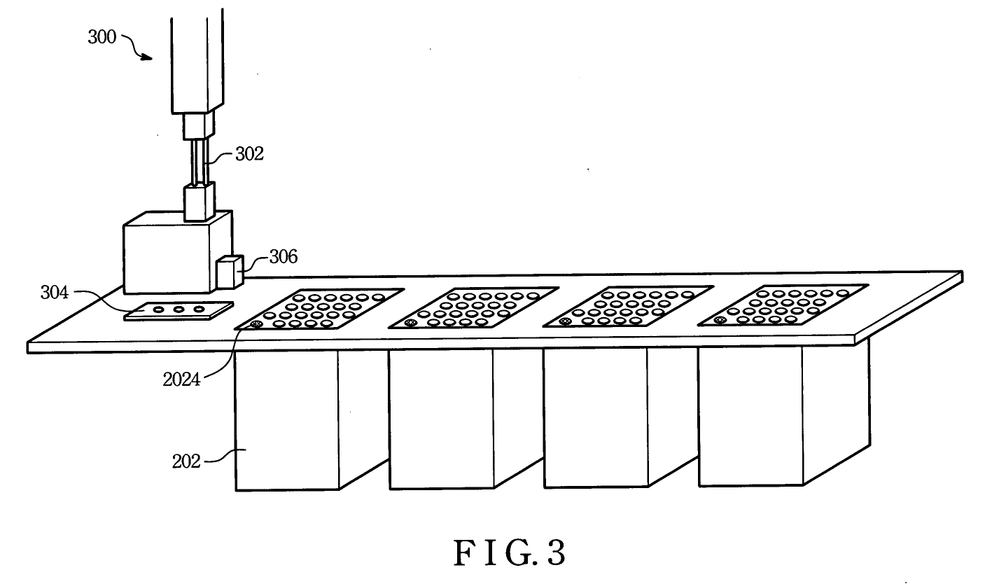

These storage holes 2022 of the barrel 202 are nest-shape or matrix arrangement. In principle, each barrel 202 only contains molding compounds 204 with the same specification, such as diameter, weight, length, etc, or the same composition. In the all system 200, the barrel 202 is a removable element. When all the molding compounds 204 in the barrel 202 are out from the barrel 202, another barrel 202 containing the molding compound 204 continues the supply process. The filling process of the barrel 202 refers to FIG. 3.

Referring to FIG. 2, the first push rod 206 is disposed below the barrel 202, and the holder 208 is disposed above the barrel 202. The first push rod 206 pushes the molding compounds 204 of the storage holes 2022 in sequence. The holder 208 continuously cooperates with the first push rod 206 and holds the molding compounds 204.

The holder 208 has a tubular structure 2082 and two shields 2084. The two shields 2084 are disposed on a wall-face of the tubular structure 2082 and can move toward an axle center thereof to the wall-face and back (as the arrowhead shows) to form a hold room in the tubular structure 2082.

As a difference from the prior art, the molding compounds 204 are ordered in the barrel 202, and the barrel 202 is removable. Then by way of the first push rod 206 pushing the molding compounds 204 out from the barrel 202 to replace the function of the oscillating plate 106 can avoid the problem in prior arts.

Based on the present invention, a simplified preferred embodiment of the system for supplying molding compounds at least has a barrel, a push rod, and a holder. The barrel has a plurality of storage holes for storing a plurality of molding compounds. The push rod is disposed below the barrel to push the molding compounds in the storage holes. The holder is disposed above the barrel to hold the molding compounds out from the push rod and transports them to a mold.

Referring to FIG. 3, the barrel 202 can add a read-write head 2024 to write a starting time in a machine 300 for arranging molding compounds. The machine 300 arranges the molding compounds 204 into the barrel 202. The structure as shown in FIG. 3 has a molding compounds weight-measuring unit 304, a molding compounds length-measuring unit 302, and a molding compounds diameter-selecting unit 306.

As shown in FIG. 3, the molding compounds length-measuring unit 302 is a tube and has a sensor (not shown in the figure) on its side to measure the length of each molding compound 204. The molding compounds weight-measuring unit 304 are as an electronic scale, and its sensitivity is adaptive to measure the weight of the molding compounds 204. The molding compounds diameter-selecting unit 306 can adjust the thickness of the molding compounds 204. All the above three units are connected to a computer or a network for an operator controlling the action or setting the needed parameters of the length, weight, diameter, etc.

Before filling the molding compounds 204, the length, weight, and diameter of the molding compounds 204 have to be measured or set in advance, and then write to the read-write head 2024. The read-write head 2024 is disposed on an upper surface of the barrel 202.

When arranging the molding compounds 204, a plurality of the barrel 202 can be arranged under the machine 300 simultaneously. As shown in the figure, the machine 300 fills the molding compounds 204 for later processing, referring to the FIG. 2.

The characters and merits of the present invention are listed as below:
1. Ordering the molding compounds into a special barrel is to let the molding compounds packed in the barrel keep a condition of having the same specification and composition. And the molding compounds are pushed out from the barrel by the push rod so as to avoid the problem caused by the oscillating plate.
2. The barrel can be dismantled for easy maintenance
3. The quality and specifications can be controlled by measuring the length, the weight, and the diameter of the molding compounds.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A system for supplying molding compounds, comprising:
a barrel, having a plurality of storage holes for storing a plurality of molding compounds;
a first push rod located below the barrel for pushing the molding compounds within the storage holes;
a holder located above the barrel for holding the molding compounds pushed by the first push rod;
a carrier having a plurality of placing holes for the holder putting the molding compounds, wherein the holder moves to a predetermined position after putting the molding compounds; and
a second push rod located below the predetermined position for pushing the molding compounds located in the placing holes, and then the holder holding and transporting the molding compounds to a mold.

2. The system for supplying the molding compounds according to claim 1, wherein the storage holes of the barrel are nest-shape arrangement.

3. The system for supplying the molding compounds according to claim 1, wherein the first push rod pushes the molding compounds in the storage holes in order.

4. The system for supplying the molding compounds according to claim 3, wherein the holder holds the molding compounds based on the push sequence of the first push rod.

5. The system for supplying the molding compounds according to claim 1, wherein the barrel has a read-write head to write a starting time in a machine for arranging molding compounds.

6. The system for supplying molding compounds according to claim 1, further comprising a machine for arranging the molding compounds into the barrel, wherein the machine comprises a molding compounds weight-measuring unit.

7. The system for supplying molding compounds according to claim 1, further comprising a machine for arranging the molding compounds into the barrel, and the machine comprising a molding compounds length-measuring unit.

8. The system for supplying molding compounds according to claim 1, further comprising a machine for arranging the molding compounds into the barrel, wherein the machine comprises a molding compounds diameter-selecting unit.

9. The system for supplying molding compounds according to claim 1, wherein the holder comprises a tubular structure and two shields, and the two shields are disposed on a wall-face of the tubular structure and can move toward an axle center thereof to form a hold room in the tubular structure.

10. A system for supplying molding compounds, comprising:
a barrel, having a plurality of storage holes formed as nest-shape arrangement for storing a molding compound;
a push rod located below the barrel being through the storage holes so as to push the molding compounds; and
a holder located above the barrel for holding the molding compound pushed by the push rod.

11. The system for supplying molding compounds according to claim 10, wherein the push rod pushes the molding compounds in the storage holes in order.

12. The system for supplying molding compounds according to claim 11, wherein the holder holds the molding compounds based on the sequence of the push rod.

13. The system for supplying molding compounds according to claim 10, wherein the barrel has a read-write head to write a starting time in a machine for arranging molding compounds.

14. The system for supplying molding compounds according to claim 10, further comprising a machine to arrange the molding compounds into the barrel, and the machine comprising a molding compounds weight-measuring unit.

15. The system for supplying molding compounds according to claim 10, further comprising a machine to arrange the molding compounds into the barrel, and the machine comprising a molding compounds length-measuring unit.

16. The system for supplying molding compounds according to claim 10, further comprising a machine to arrange the molding compounds into the barrel, wherein the machine comprises a molding compounds diameter-selecting unit.

17. The system for supplying molding compounds according to claim 10, wherein the holder comprises a tubular structure and two shields, and the two shields are disposed in a wall-face of the tubular structure and can move toward an axle center thereof to form a hold room in the tubular structure.
